(19) United States
(12) Patent Application Publication
(10) Pub. No.: US 2008/0013101 A1
(43) Pub. Date: Jan. 17, 2008

(54) Repairing method for dark areas on a surface profile and a surface profile measuring method

(75) Inventors: Yaomin Lin, Hsinchu City (TW); Hung-Chang Chang, Kaohsiung City (TW)

Correspondence Address: BRUCE H. TROXELL, SUITE 1404, 5205 LEESBURG PIKE, FALLS CHURCH, VA, 22041, US

(73) Assignee: CHROMA ATE INC.

(21) Appl. No.: 11/486,311

(22) Filed: Jul. 14, 2006

(51) Int. Cl. G01B 11/02

(52) U.S. Cl. 356/511

(57) ABSTRACT

A repairing method for a surface profile is provided. The intensity on the waveform of the interference diagrams or the existence of envelope on the waveform of the interference diagram are used to decide whether the respected pixel is located in a dark area on the surface profile or not. Then, mark the pixel located in the dark area. Afterward, repair the marked pixel by using the surrounding effective pixels on the surface profile.

### BACKGROUND OF THE INVENTION

(1) Field of the Invention

This invention relates to a repairing method for a surface profile, and more particularly relates to a repairing method for dark areas on the surface profile.

(2) Description of the Prior Art

An non-contact surface profile measuring apparatus with white light interferometry is broad applied for high accuracy demands, such as semiconductor wafers, glass substrate of LCD, and etc.

FIG. 1 shows a typical non-contact surface profile measuring apparatus, which has a light source 10, a collimation lens 20, a beamsplitter 30, an imaging lens 40, an image sensing device 40, an interferometer 60, a stage 70, and a computer system 80. The beams from the light source 10 are directed by the collimation lens 20 to the beamsplitter 30. The beamsplitter 30 reflects the beams to the interferometer 60.

The interferometer 60 is located above the stage 70 and aligned to the sample surface 90 supported by the stage 70. The interferometer 60 has a microscope objective 62, a reflector 64, and a beamsplitter 66, wherein the microscope objective 62 is located above the reflector 64 and the reflector 64 is located above the beamsplitter 66. Part of the beams penetrating the microscope objective 62 are reflected upward by the beamsplitter 66 and re-reflected downward by the reflector 64, and part of the beams penetrate the beamsplitter 66 downward to the sample surface directly.

The beams reflected by the beamsplitter 66 and the beams penetrating the beamsplitter are reflected by the sample surface 90 and recombined in the beamsplitter 66. The recombined beams then penetrate the microscope objective 62, the beamsplitter 30, and focus on the image sensing device 50 through the imaging lens 40. It is noted that the optical path of the two beams recombined in the beamsplitter 66 are different.

The value of optical path difference (OPD) is decided by a distance between the interferometer 60 and the stage 70. Thus, a serial of interference images with respect to different OPD values may be accessed by the image sensing device 50 by precisely varying the vertical position of the interferometer 60 or the stage 70 with predetermined steps. The intensity variation of the pixels with the same location on the interference images with respect to different OPD values is then derived by the computer system 80 to show the waveform of FIG. 2.

The waveform shown in FIG. 2 is a typical white light interferometry waveform, which is characterized with an “envelope”. The peak position of the envelope decides the respected height of the portion on the sample surface. The height variation on the whole sample surface may be derived by the same way to form a surface profile.

It is noted that in case of over-low reflectivity, dark color, or sharp profile, the beams reflected by the sample surface may be too weak to generate effective data for the formation of surface profile. The respected area on the surface profile is regarded as dark area. FIG. 3 shows a waveform of such dark area. Since the waveform has no significant envelope, the estimation of the respected height on the surface profile may show a significant error.

In order to solve the problem, a typical method uses a space filter to remove the unwanted errors due to poor reflectivity on the sample surface, after the surface profile data, such as the peak position of the envelope, being derived. However, due to the lack of location and characteristic of the dark areas, the present method only shows limited improvement.

Accordingly, how to mark and repair the dark areas effectively has been quite an important issue to enhance the credibility of surface profile measurement.

### SUMMARY OF THE INVENTION

It is a main object of the present invention to mark the dark areas as the interference data being accessed so as to effectively repair the dark area.

A repairing method for dark areas on a surface profile is provided in the present invention. The surface profile is formed by using surface profile measuring method with white light interferometry. The surface profile measuring method illuminates a sample surface and a reference surface and changes the distance between the two surfaces with a predetermined step distance so as to form a serial of interference images. The intensity variation of the pixels with the same location on the interference images is utilized to form the interference diagram, which shows a relationship of height versus intensity.

The repairing method uses the interference diagram to decide whether the respected pixel located in a dark area or not, and mark pixel located in the dark area. Then, in the formation of the surface profile, the marked pixel is repaired by using the surrounding effective pixels.

According to the above mentioned repairing method, a surface profile measuring method is also provided in the present invention. The surface profile measuring method comprises the steps of: (1) illuminating a sample surface and a reference surface by using a broad bandwidth light source; (2) changing the distance between the sample surface and the reference surface with a predetermined step distance to form a serial of interference images; (3) forming interference diagrams, which show a relationship of height versus intensity, by using intensity variation of pixels with the same location on the interference images; (4) deciding whether the respected pixel located in a dark area or not by using the waveform in the interference diagram, and marking the pixel located in the dark area; (5) forming a surface profile of the sample surface with marked pixels; and (6) repairing the marked pixels by using the surrounding effective pixels on the surface profile.

In an embodiment of the present invention, the highest intensity on the waveform in the interference diagram is utilized to decide whether the respected pixel located in the dark area or not.

In an embodiment of the present invention, data of the waveform is pre-operated. The highest pre-operated value is utilized to decide whether the respected pixel located in the dark area or not.

In an embodiment of the present invention, the existence of a significant envelope on the waveform is used to decide whether the respected pixel located in a dark area or not.

In an embodiment of the present invention, the marked pixel is repaired by using an average value of surrounding effective pixels on the surface profile.

In an embodiment of the present invention, the marked pixel is repaired by using values of two nearest effective pixels in the opposite directions from the marked pixel.

In an embodiment of the present invention, the marked pixel is repaired by using values of neighboring effective pixels along the longitude axis, vertical axis, and two tilting axes, which make an 45 degrees with the longitude axis, form the marked pixel.

### BRIEF DESCRIPTION OF THE DRAWINGS

The present invention will now be specified with reference to its preferred embodiment illustrated in the drawings, in which:

FIG. 1 shows a schematic view of a typical surface profile measuring apparatus;

FIG. 2 is an interference diagram showing a typical white light interferometry waveform with effective data;

FIG. 3 is an interference diagram showing a waveform with respect to the dark area;

FIG. 4 is a flow-chart of a preferred embodiment of the surface profile measuring method in accordance with the present invention;

FIG. 5 is a schematic view showing a first preferred embodiment of step C in FIG. 4;

FIG. 5A is a flow-chart showing the first preferred embodiment of step C in FIG. 4;

FIG. 6 is a schematic view showing a second preferred embodiment of step C in FIG. 4;

FIG. 7 is a schematic view showing a third preferred embodiment of step C in FIG. 4;

FIG. 7A is a flow-chart showing the third preferred embodiment of step C in FIG. 4;

FIG. 8 is a flow-chart showing a first preferred embodiment to step E in FIG. 4;

FIG. 9 is a flow-chart showing a second preferred embodiment to step E in FIG. 4; and

FIG. 10 is a flow-chart showing a third preferred embodiment to step E in FIG. 4.

### DESCRIPTION OF THE PREFERRED EMBODIMENTS

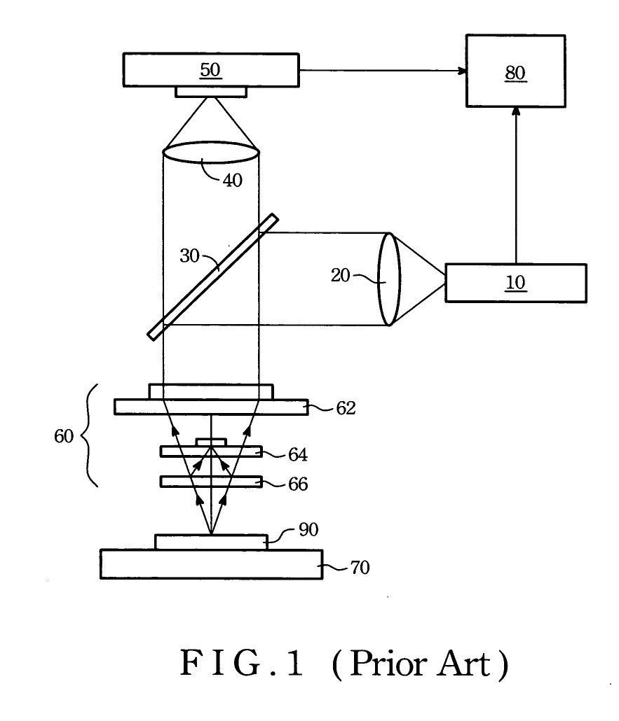

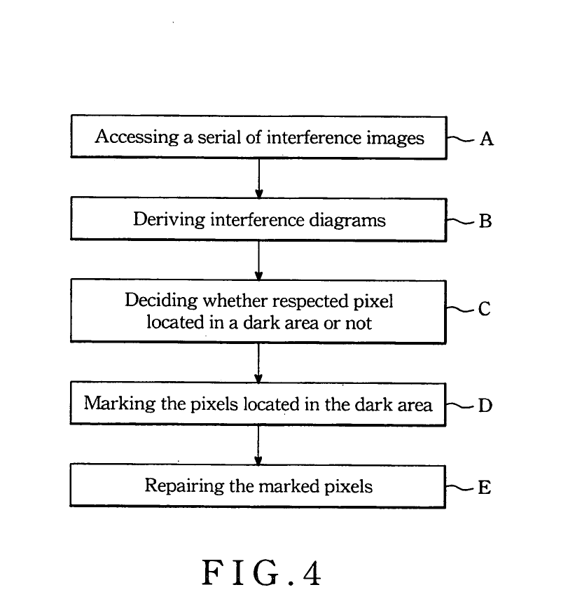

FIG. 4 is a flow chart depicting a preferred embodiment of the surface profile measuring method in accordance with the present invention, which uses the typical non-contact surface profile measuring apparatus as shown in FIG. 1 to measure the surface profile of a sample surface 90. The beams from the broad bandwidth light source 10 illuminate the sample surface 90 and a reference surface on the reflector 64. In step A, a serial of interference images are accessed by changing the distance between the sample surface 90 and the reference surface (or the interferometer 60) with a predetermined step distance. In step B, interference diagrams showing a relationship of height versus intensity are derived by using the intensity variation of the pixels with the same locations on the interference images. It is noted that every pixels on the interference image has a respected interference diagram.

Afterward, in step C, according to the waveform in the interference diagram to decide whether the respected pixel located in a dark area or not. Then, in step D, the surface profile of the sample surface with marked pixels located in the dark area is formed. Thereafter, in step E, the marked pixels are repaired by using the values of the surrounding effective pixels on the surface profile.

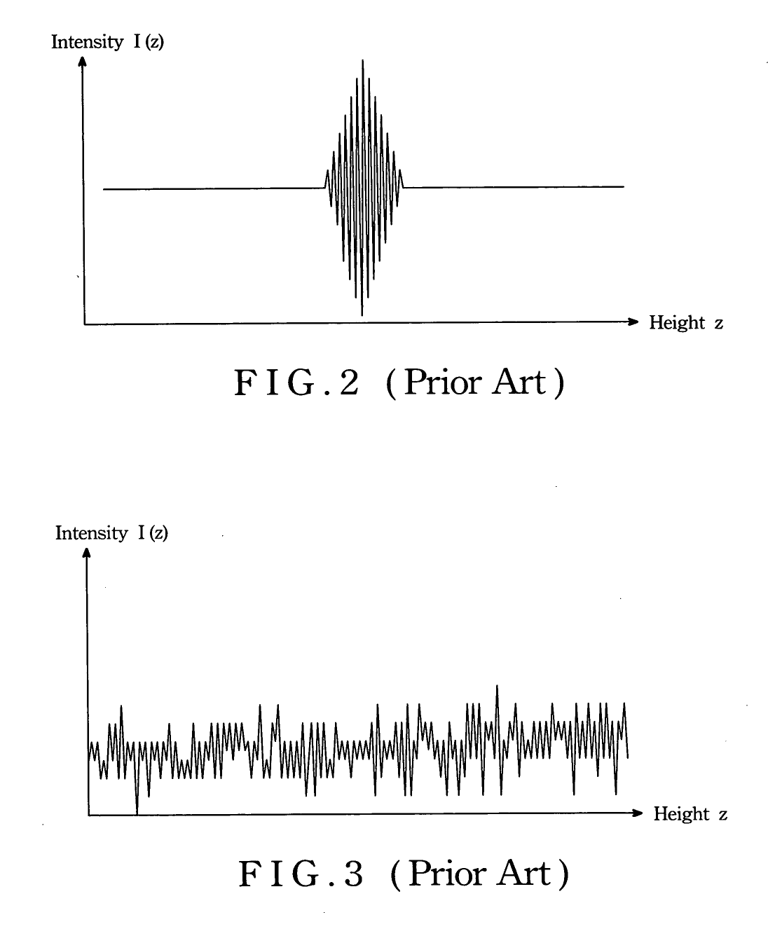

FIG. 2 is an interference diagram showing a typical white light interferometry waveform with respect to the effective pixel on the surface profile, and FIG. 3 shows a waveform of the pixel located in the dark area on the surface profile. As shown, the waveform with respect to the effective pixel has a significant “envelope” and interference fringes, whereas the waveform with respect to the pixel located in the dark area has no “envelope” or even interference fringes. In addition, the highest intensity value with respect to the effective pixel is about 4 times greater than the highest intensity value with respect to the pixel located in the dark area.

Based on the difference of the waveforms in FIGS. 2 and 3, in step C, the highest intensity value on the waveform or the existence of a significant envelope on the waveform, may be used to decide whether the respected pixel located in the dark area or not.

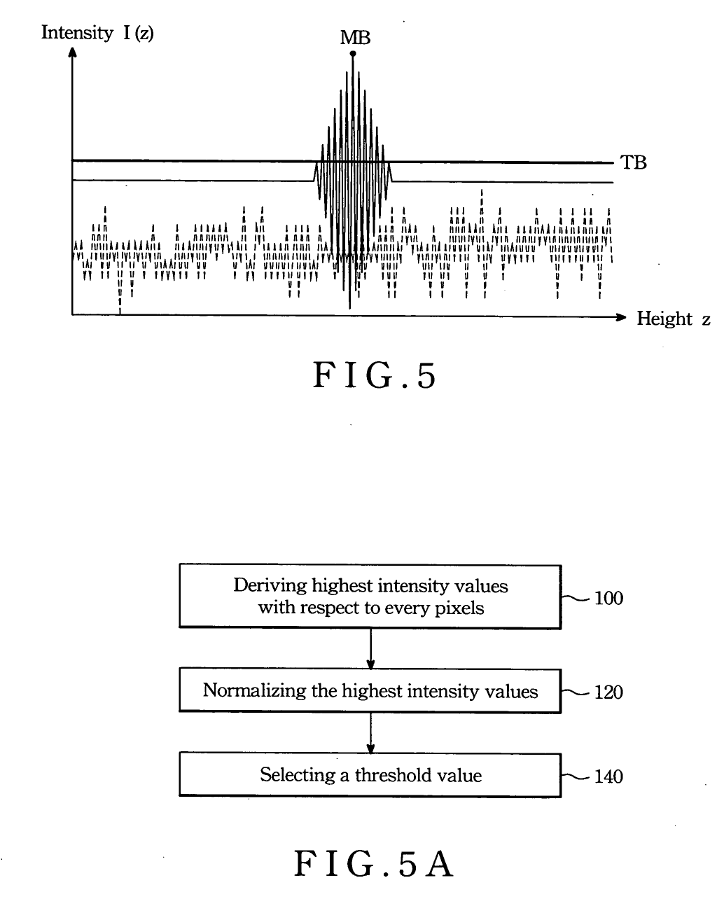

FIGS. 5 and 5A shows a first preferred embodiment of the step C as describe in FIG. 4, which uses the highest intensity value on the waveform to decide whether the respected pixel located in the dark area or not. Firstly, as shown in step 100 of FIG. 5A, the highest intensity values max(I(z)x,y) on the waveforms with respect to every pixels with the same location (x,y) on the interference images are derived.

Then, in step 120, the highest intensity values max(I(z)x,y) of every pixels with the same location (x,y) on the interference images are normalized into a comparing region range between 0 to N as follow:

Normal(max(I(z)x,y))=N×[max(I(z)x,y)−Min(max(I(z)x,y))]÷[Max(max(I(z)x,y))−Min(max(I(z)x,y))] (1)

Where, max(I(z)x,y) is the highest intensity value with respect to the pixels with the location (x,y); Normal(max(I(z)x,y)) is the normalized value of the highest intensity value max(I(z)x,y); Max(max(I(z)x,y)) is the maximum among the highest intensity values of every locations (x,y); and Min(max(I(z)x,y)) is the minimum among the highest intensity values of every location (x,y).

Then, in step 140, a threshold value in the comparing region is selected. As the normalized value Normal(max(I(z)x,y)) being smaller than the threshold value, the respected pixel on the surface profile is regarded as located in the dark area.

The above mentioned method comparing the highest intensity value on the waveform with respect to a threshold value may be understood as selecting a threshold intensity value TB as shown in FIG. 5. As the highest intensity value being smaller than the threshold intensity value TB, the respected pixel on the surface profile may be regarded as located in the dark area. In addition, the threshold intensity value TB may be ranged between 0 to 75% of the maximum among the highest intensity values as a preferred embodiment in accordance with the present invention.

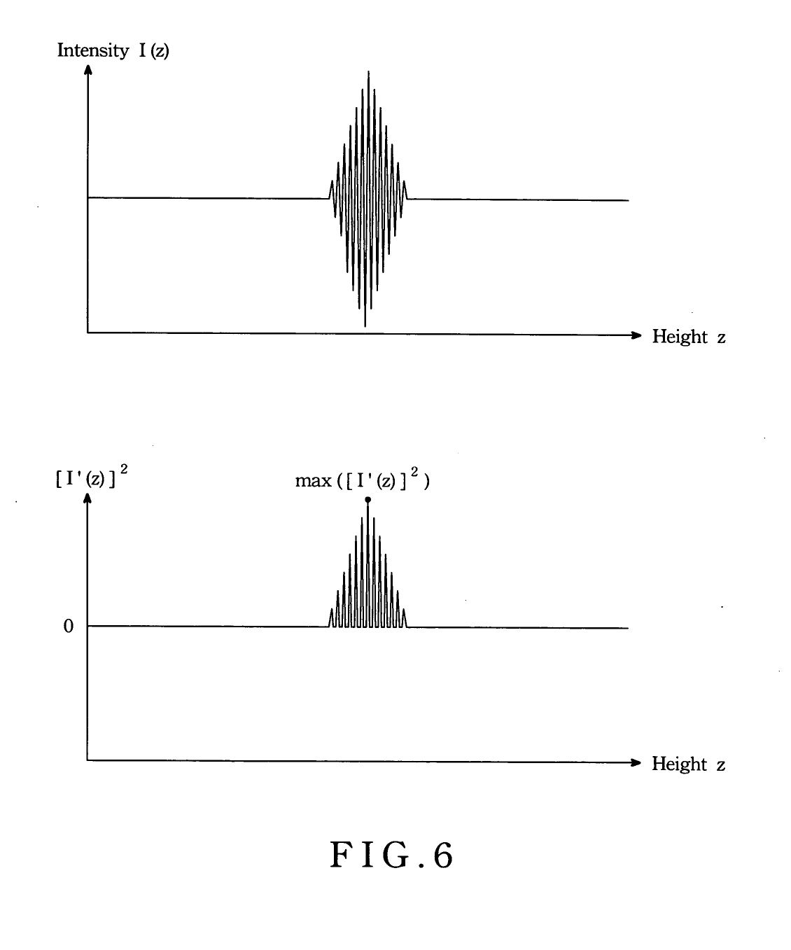

Except the method of using the highest intensity values on the waveforms directly, FIG. 6 shows a second preferred embodiment of the step C, which pre-operates the function I(z) of the waveform accessed in step B to derive a first differential function I′(z) to decide the position of the highest intensity value on the waveform. The first differential function I′(z) may be understood as a function describing the difference between intensity values I(z) and I(z−1). Then, find out the maximum value max([I′(z)]²) on the squared first differential function. As the maximum value max([I′(z)]²) being smaller than a selected threshold value T2, the respected pixel may be regarded as located in a dark area. Ordinarily, the maximum value max([I′(z)]²) and the greatest intensity value max(I(z)x,y) are respected to an identical height z.

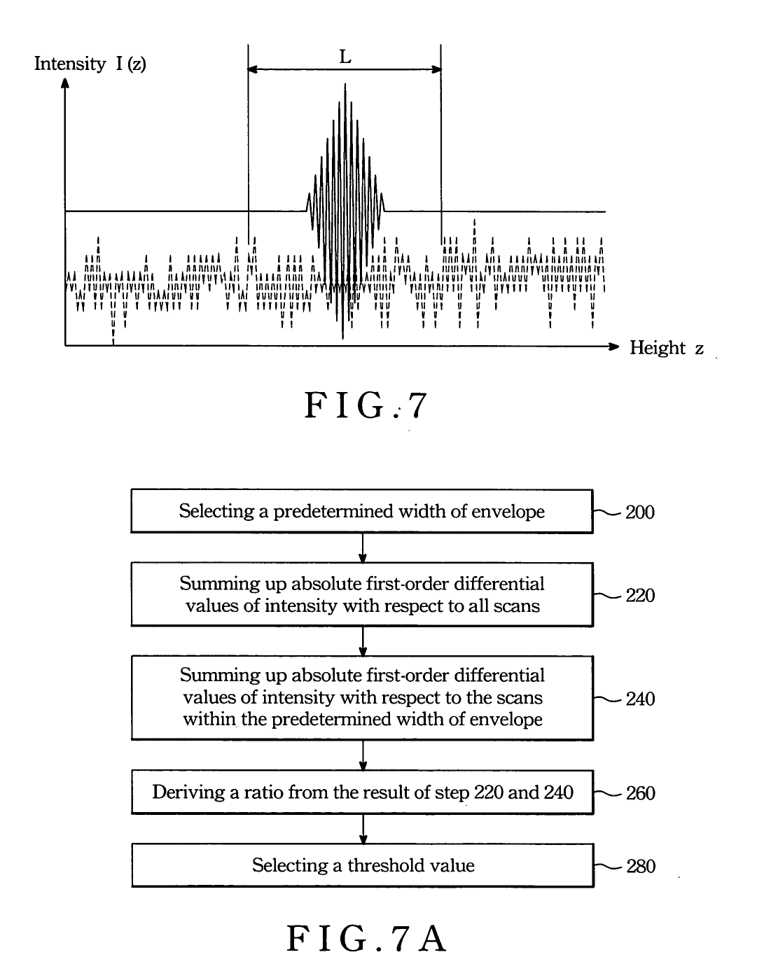

FIGS. 7 and 7A shows a third preferred embodiment of the step C as shown in FIG. 4, which decides whether the pixel located in the dark area according to the existence of a significant “envelope” on the waveform in the interference diagram. Firstly, in step 200, a predetermined width of envelope L is selected according to the width of existed envelopes on the waveforms. The number of scans, or the number of respected interference images, with respect to the predetermined width of envelope is calculated according to the step distance.

Then, in step 220, sum up the absolute first-order differential values of intensity with respect to all the scans on the waveform to access a value of whole scan E(x,y). In addition, in step 240, sum up the absolute first-order differential values of intensity with respect to the scans with respect to the predetermined width of envelope to access a value of envelope portion D(x,y).

Afterward, in step 260, a ratio R(x,y) is derived by dividing the value of envelope portion D(x,y) into the value of whole scan E(x,y). Moreover, in step 280, a threshold value ranged between 0 and 1 is selected. As the ratio R(x,y) being smaller than the threshold value, the respected pixel is regarded as located in the dark area and marked.

After marking the pixel located in the dark area on the surface profile, different embodiments of the step E as shown in FIG. 4 for repairing various distributions of dark areas are provided in the present invention.

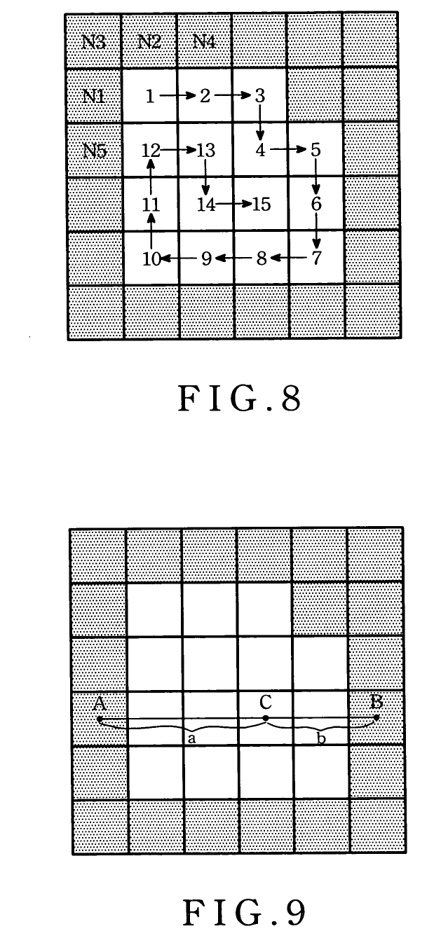

FIG. 8 shows a first preferred embodiment of the method for repairing the dark area as described in the step E. As shown, for a given marked pixel 1 located in the dark area, the average value of the adjacent effective pixels N1, N2, N3, N4, and N5 are used to repair the marked pixel 1. The present repairing method starts with the marked pixel 1 and steps inward the dark area (as the increasing of the pixel number implies). That is, the present embodiment repairs the dark area from the marked pixels located in the intersection between the marked pixels and the effective pixels and steps toward the inner of the dark area.

FIG. 9 shows a second preferred embodiment of the method for repairing the dark area as described in step E of FIG. 4. As shown, the marked pixel C within the dark area is repaired by using the values of two nearest effective pixels A,B in the opposite directions from the marked pixel C and the distances a,b between the effective pixels A,B and the marked pixel C. The value of the marked pixel C is derived according to the equation as follow:

V(C)=V(A)+(V(B)−V(A))×a÷(a+b) (2)

Where, V(A) and V(B) are the values of effective pixels A and B respectively; V(C) is the value utilized for repairing the marked pixel C; and a and b are the distances between the marked pixel C and the effective pixels A and B respectively.

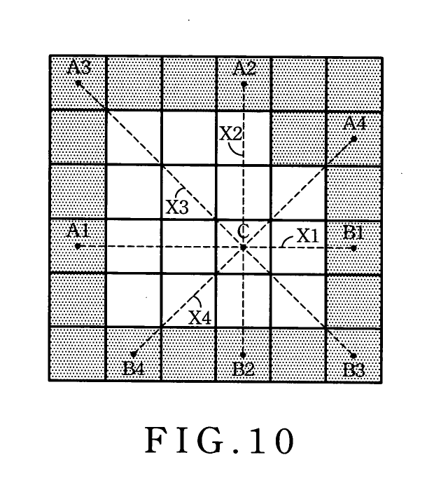

FIG. 10 shows a third preferred embodiment of the method for repairing the marked pixel as described in step E of FIG. 4. In compared with the method of FIG. 8, which uses the effective pixels A, B located along a longitude axis to repair the marked pixel C, the present embodiment repairs the marked pixel C by using the values of effective pixels Ai, Bi located along four axes Xi including a longitude axis, a vertical axis, and two tilting axes, which make an 45 degrees with the longitude axis (i=1˜4).

Since the distances between the marked pixel and the effective pixels as well as the values of the effective pixels along the four axes Xi may be different. The weight of each axis Xi should be concerned as follow:

W(i)=|V(Ai)−V(Bi)|÷(ai+bi);

Where, V(Ai) and V(Bi) are the values of nearest effective pixels Ai and Bi in the opposite directions along axis Xi with respect to the mark pixel C; and ai and bi are the distances from the marked pixel C to the effective pixels Ai and Bi respectively. Four weights W(i) respecting to the four axes Xi (i=1˜4) are derived.

The respected weight w(i) along each axis Xi is calculated as follow:

w(i)=W(i)+(W(1)+W(2)+W(3)+W(4));

Where, w(i) is the respected weight of axis Xi; and W(i) is the weight with respect to the axis Xi (i=1˜4).

Then, apply the respected weight w(i) into equation (2) as follow:

V(Ci)=[V(Ai)+(V(Bi)−V(Ai))×a÷(ai+bi)]×w(i) (3)

The equation (3) is utilized to access four contribution values V(Ci) of the four axes Xi (i=1˜4). The four contribution values V(Ci) are summed up to access the exact value for repairing the marked pixel as follow:

V(C)=V(C1)+V(C2)+V(C3)+V(C4) (4)

In compared with the traditional method of filtering the error messages of the surface profile data due to poor surface reflectivity, the present invention marks the pixel in the dark area on the surface profile by using the waveform in the interference diagram, which is accessed before the surface profile data being derived. In addition, the marked pixels on the surface profile may be effectively repaired by using the values of effective pixels surrounding the marked pixels. As s result, the problems encountered by the traditional repairing method due to the lack of location and characteristic information of the dark area may be prevented.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A repairing method for dark areas on a surface profile, which is formed by using a surface profile measuring method, the surface profile measuring method illuminating a sample surface and a reference surface by using a broad bandwidth light source and changing a distance between the sample surface and the reference surface with a predetermined step distance to form a serial of interference images utilized to derive waveforms of interference diagrams describing a relationship of height versus intensity with respect to every pixels on the surface profile respectively, the method comprising the steps of:
deciding whether the respected pixel being located in the dark area or not according to the waveform;
marking the pixel located in the dark area; and
repairing the marked pixel by using surrounding effective pixels on the surface profile.

2. The repairing method of claim 1 wherein the step of deciding whether the respected pixel being located in the dark area or not is to compare a highest intensity value on the waveform with a threshold intensity value, and as the highest intensity value being smaller than the threshold intensity value, the respected pixel is regarded as being located in the dark area.

3. The repairing method of claim 1 wherein the step of deciding whether the respected pixel being located in the dark area or not comprising the steps of:
deriving the highest intensity values with respect to every pixels on the surface profile according to the waveforms;
normalizing the highest intensity values into a comparing region; and
selecting a threshold value in the comparing region, and as the normalized highest intensity value being smaller than the threshold value, the respected pixel being regarded as located in the dark area.

4. The repairing method of claim 1 wherein the step of deciding whether the respected pixel being located in the dark area or not comprising the steps of:
pre-operating the waveform to access an operated value with respect to the highest intensity value on the waveform; and
as the operated value being smaller than a threshold value, the respected pixel being regarded as located in the dark area.

5. The repairing method of claim 4 wherein the step of pre-operating the function of the waveform comprising a first-order differential operation.

6. The repairing method of claim 1 wherein the step of deciding whether the respected pixel being located in the dark area or not is to monitor the existence of a significant envelope on the waveform, and as no significant envelope existed, the respected pixel is regarded as located in the dark area.

7. The repairing method of claim 6 wherein the step of decide whether the respected pixel being located in the dark area or not comprising the steps of:
selecting a predetermined width of envelope according to the existing envelopes on the waveforms;
calculating number of scans included in the predetermined width;
summing up absolute first-order differential values of intensity with respect to all the scans on the waveform to access a value of whole scan;
summing up absolute first-order differential values of intensity with respect to the scans with respect to the predetermined width to access a value of envelope portion;
dividing the value of envelope portion into the value of whole scan to access a ratio; and
selecting a threshold value between 0 and 1, and as the ratio being smaller than the threshold value, the respected pixel being regarded as located in the dark area.

8. The repairing method of claim 1 wherein the step of repairing the marked pixel uses an average value of the adjacent effective pixels on the surface profile to repair the marked pixel.

9. The repairing method of claim 1 wherein the step of repairing the marked pixel uses values of two nearest effective pixels located on the opposite directions from the marked pixel.

10. The repairing method of claim 1 wherein the step of repairing the marked pixel uses values of nearest effective pixels located along a longitude axis, a vertical axis, two tilting axes, which make an angle of 45 degree with respect to the longitude axis, from the marked pixel.

11. The repairing method of claim 2, wherein the threshold intensity value is about 0 to 75% of maximum of the highest intensity values with respect to all the pixels.

12. A surface profile measuring method comprising the steps of:
illuminating a sample surface and a reference surface by using a broad bandwidth light source and changing a distance between the sample surface and the reference surface with a predetermined step distance to form a serial of interference images;
forming a waveform on an interference diagram by using intensity variation of pixels with the same location on the interference images;
according to whether a significant envelope being existed on the waveform or not to decide whether the respected pixel being located in a dark area on the surface profile;
forming the surface profile and marking the pixel located in the dark area; and
repairing the marked pixel by using surrounding effective pixels on the surface profile.

13. The surface profile measuring method of claim 12 wherein the step of deciding whether the respected pixel being located in the dark area or not is to compare a highest intensity value on the waveform with a threshold intensity value, and as the highest intensity value being smaller than the threshold intensity value, the respected pixel is regarded as being located in the dark area.

14. The surface profile measuring method of claim 12 wherein the step of deciding whether the respected pixel being located in the dark area or not comprising the steps of:
deriving the highest intensity values with respect to every pixels on the surface profile according to the waveforms;
normalizing the highest intensity values into a comparing region; and
selecting a threshold value in the comparing region, and as the normalized highest intensity value being smaller than the threshold value, the respected pixel being regarded as located in the dark area.

15. The surface profile measuring method of claim 12 wherein the step of deciding whether the respected pixel being located in the dark area or not comprising the steps of:
pre-operating a function of the waveform to access an operated value with respect to the highest intensity value on the waveform; and
as the operated value being smaller than a threshold value, the respected pixel being regarded as located in the dark area.

16. The surface profile measuring method of claim 15 wherein the step of pre-operating the function of the waveform comprising a first-order differential operation.

17. The surface profile measuring method of claim 12 wherein the step of deciding whether the respected pixel being located in the dark area or not is to monitor the existence of a significant envelope on the waveform, and as no significant envelope existed, the respected pixel is regarded as located in the dark area.

18. The surface profile measuring method of claim 17 wherein the step of decide whether the respected pixel being located in the dark area or not comprising the steps of:
selecting a predetermined width of envelope according to the existing envelopes on the waveforms;
calculating number of scans included in the predetermined width;
summing up absolute first-order differential values of intensity with respect to all the scans on the waveform to access a value of whole scan;
summing up absolute first-order differential values of intensity with respect to the scans with respect to the predetermined width to access a value of envelope portion;
dividing the value of envelope portion into the value of whole scan to access a ratio; and
selecting a threshold value between 0 and 1, and as the ratio being smaller than the threshold value, the respected pixel being regarded as located in the dark area.

19. The surface profile measuring method of claim 12 wherein the step of repairing the marked pixel uses an average value of the adjacent effective pixels on the surface profile to repair the marked pixel.

20. The surface profile measuring method of claim 12 wherein the step of repairing the marked pixel uses values of two nearest effective pixels located on the opposite directions from the marked pixel.

21. The surface profile measuring method of claim 12 wherein the step of repairing the marked pixel uses values of nearest effective pixels located along a longitude axis, a vertical axis, two tilting axes, which make an angle of 45 degree with respect to the longitude axis, from the marked pixel.

22. The surface profile measuring method of claim 13, wherein the threshold intensity value is about 0 to 75% of maximum of the highest intensity values with respect to all the pixels.

23. A repairing method for dark areas on a surface profile, which is formed by using a surface profile measuring method, the surface profile measuring method illuminating a sample surface and a reference surface by using a broad bandwidth light source and changing a distance between the sample surface and the reference surface with a predetermined step distance to form a serial of interference images utilized to derive waveforms on interference diagrams describing a relationship of height versus intensity with respect to every pixels of the surface profile respectively, the repairing method comprising the steps of:
deciding whether the respected pixel being located in the dark area or not according to whether an pre-operated value from data of the waveform being greater than a threshold value or not, or whether a significant envelope existed on the waveform or not;
marking the pixel being located in the dark area; and
repairing the marked pixel by using surrounding effective pixels on the surface profile.

24. The repairing method of claim 23 wherein the step of deciding whether the pre-operated value from data of the waveform being greater than a threshold value or not comprising the steps of:
deriving the highest intensity values with respect to every pixels on the surface profile according to the waveforms;
normalizing the highest intensity values into a comparing region; and
selecting the threshold value in the comparing region, and as the normalized highest intensity value being smaller than the threshold value, the respected pixel being regarded as located in the dark area.

25. The repairing method of claim 23 wherein the step of deciding whether the pre-operated value from data of the waveform being greater than a threshold value or not comprising the steps of:
pre-operating a function of the waveform to access an operated value with respect to the highest intensity value on the waveform; and
as the operated value being smaller than a threshold value, the respected pixel being regarded as located in the dark area.

26. The repairing method of claim 25 wherein the step of pre-operating the function of the waveform comprising a first-order differential operation.

27. The repairing method of claim 23 wherein the step of decide whether a significant envelope existed on the waveform or not comprising the steps of:
selecting a predetermined width of envelope according to the existing envelopes on the waveforms;
calculating number of scans included in the predetermined width;
summing up absolute first-order differential values of intensity with respect to all the scans on the waveform to access a value of whole scan;
summing up absolute first-order differential values of intensity with respect to the scans with respect to the predetermined width to access a value of envelope portion;
dividing the value of envelope portion into the value of whole scan to access a ratio; and
selecting a threshold value between 0 and 1, and as the ratio being smaller than the threshold value, the respected pixel being regarded as located in the dark area.

28. The repairing method of claim 23 wherein the step of repairing the marked pixel uses an average value of the adjacent effective pixels on the surface profile to repair the marked pixel.

29. The repairing method of claim 23 wherein the step of repairing the marked pixel uses values of two nearest effective pixels located on the opposite directions from the marked pixel.

30. The repairing method of claim 23 wherein the step of repairing the marked pixel uses values of nearest effective pixels located along a longitude axis, a vertical axis, two tilting axes, which make an angle of 45 degree with respect to the longitude axis, from the marked pixel.
